(19) United States
(12) Patent Application Publication
(10) Pub. No.: US 2006/0260162 A1
(43) Pub. Date: Nov. 23, 2006

(54) Multiple static cling sign method

(76) Inventor: Anna M. Ballinger, Derby, KS (US)

Correspondence Address: Bradley P. Sylvester, Suite 300, 200 North Broadway, Wichita, KS, 67202, US

(21) Appl. No.: 11/131,857

(22) Filed: May 18, 2005

(51) Int. Cl. G09F 21/04

(52) U.S. Cl. 40/591

(57) ABSTRACT

A method of displaying signs for providing information to observers regarding structures and any means of transportation. This method finds the greatest applicability in the promotion and sale of these items. The signs used involve adhesion using static cling methods, that allow the signs to be easily removed and replaced. The information on the signs is presented in a variable format, including repetitive, unique, or a combination of repetitive and unique information. The signs are visible from multiple angles and/or locations, and are able to be placed within and without the vehicle or structure. The advantages of this method is that multiple signs present a continuous visual barrage of information to an observer, which assists in the conveying of information to potential customers. This method also finds use on items contained in structures, for stores and museums, where the signs convey desired information and/or messages.

### BACKGROUND OF THE INVENTION

The use of signs and placards has been a longstanding method of conveying information to potential customers. It is generally understood that repetitious advertising is effective in conveying information that is retained by the observer more readily than a single ad or sign.

Signs and placards are also useful in retaining information for the end user of a product. For example, in U.S. Pat. No. 3,508,356 (Ross), an information card is shown, regarding the placement of pertinent maintenance information about a vehicle. Information is able to be written on the card, which is then typically placed into the glove box. This particular card is secured to metal surfaces within the glove box using magnetic strip tape. The card had advantages in providing useful information, and being able to be removed when desired. In modem motor vehicles, the card and attachment means are generally not usable as the Ross patent envisioned. First, there is a lack of metal in glove boxes, which would deny magnetic attachment. Further, the information would better be used so that the information is able to be on display at all times. The display would need to be visible, and yet not interfere with operation of the motor vehicle.

The placement of signs on glass for advertising has a particular appeal in the trade of motor vehicles. Motor vehicles have a rapid turnover, and the signs must be eyecatching, be able to convey necessary information, and preferably be removeable when desired. It is a memorable event to take a new motor vehicle home, and proudly display the vehicle information sheet that has been securely adhered to the window of the vehicle. Then, there is the removal process, that requires scraping and effort to remove the adhesive. This becomes even more problematic if the information sheet or sign was secured on the side of the glass with the tinting layers, since the owner must be careful not to damage the tinting layer during removal. The same concerns apply to any signage that would be used during the sales and marketing process.

The use of static cling materials to provide a platform for visual information for the convenience of the user or other people is exampled in U.S. Pat. No. 6,324,777 (Ngan). In Ngan, the information recorded and displayed was a calender. It is not very useful for motor vehicles and structures, but the benefits of having information that was permanently printed on a clinging sheet, along with the ability to add unique information was shown.

Other signage has attempted to take advantage of the clinging characteristics of static cling materials. In U.S. Pat. No. 5,352,535 (Su), a message board having multiple layers is disclosed, where the top surface is able to be written upon, and where the underside base is able to be adhered to other smooth surfaces. The base layer adheres to slick surfaces, but is only usable if placed on exterior of a vehicle window, as opposed to the interior surface, causing the sign or banner to be subject to inclement weather. The invention in Su does not provide the benefits of the present invention, regarding repetitive information, and the mounting of the signage on the inside, or tinted side, of the motor vehicle window glass.

The use of eye-catching signage for use in automobile sales, where the sign is capable of being altered as needed, is disclosed in U.S. Pat. No. 5,899,010 (Peck). In Peck, a static cling banner is disclosed, in which the underlying surface provides a stable media upon which lettering or other artistic items are able to be placed thereon. The banner itself is supported separately, and would only be useful with motor vehicles or buildings if it was able to be tied down or secured separately.

The use of banners on motor vehicles is also shown in U.S. Pat. No. 6,640,477 (Timson et al.), in which a motor vehicle advertising banner is placed across the front windshield of motor vehicles that are offered for sale. In Timson et al., the banner is strictly limited to placement on motor vehicle windshields. A single banner is used, with specific information required on the banner. The benefits of this banner is that it is capable of being repositioned on additional windshields and finding usefulness in offering subsequent vehicles for sale, without causing undo visual restriction for the potential buyer.

### SUMMARY OF THE INVENTION

This invention is intended to provide a means, whereby specific information necessary to the viewer is made available, through the use of a static cling material that contains both preprinted information and additional unique information that is pertinent to the item to which the sign is attached. The sign allows information to be viewed both externally and internally, if so desired. When used with motor vehicles, this invention is usable as an advertising tool, which is capable of being placed in more than one window, and is able to be viewed from the sides, front, as well as from the rear. This allows a virtual barrage of advertising information and maximizes the information perceived by percipient viewers. In addition, information on these signs is also able to be viewed from within the motor vehicle itself, and can be used to both help sell a vehicle as well as provide information crucial to the maintenance and/or upkeep of said vehicle. Therefore, the sign's usefulness continues even during a test drive.

This novel sign method is useful when dealing with the sale or lease of motor vehicles, and since the signage is often present on a vehicle until it is sold, it maintains its position on the vehicle as well as having the capability to be removed if necessary for use on subsequent vehicles. In addition, it can be removed or repositioned within the vehicle it is already on. Since adverse weather conditions can affect external signs, the nature of adhesion for this present invention, using a static cling method, allows the visual sign to be placed within the interior of the motor vehicle.

This signage is also useful in buildings, restaurants, as well as businesses of any kind, to promote activities, goods or services located therein. When used to help advertise the sale or lease of real property, certain terms and conditions may be preprinted on the sign so as to make the sign recognizable from item to item, in that a viewer who has an opportunity to review multiple signs will be able to quickly assess the information that they are looking for, due to the fact that the signs themselves have uniformity between them as to placement and content of information.

These signs are not limited to motor vehicles, but also have a use in the marketing of real property. Placement of the signs provides a novel method of repeatedly allowing potential buyers to receive certain information deemed helpful by the seller or lessor. For example, larger signs are appropriate in windows or may be placed on large glass doors. Smaller versions of these signs, having identical or abbreviated information, may be placed on other windows and mirrors so that a person walking through a house would find helpful information at the various locations when the structure. These signs allow potential buyers to repeatedly view information that will encourage their propensity to engage in contractual negotiations with the seller. The signs may be reused again in different locations, since they are only attached to their surfaces through the static cling materials in the signs themselves. Removal of the signs from windows, be on a structure, or on a motor vehicle, also should leave no residue, or interfere with tinting. The present invention leaves no residue, and does not interfere or damage window tinting layers.

This same repetition of signage placement is also appropriate for motor vehicles as well as dwellings, and also appropriate for businesses of many types. This includes museums, retail stores, as well as marketers of motor vehicles and real property. In all instances where the present signs are used, the viewer gains important information that is more readily processed and taken into account, since the information itself is able to repeatedly be displayed and viewed.

Accordingly, it is the object of this invention to provide signage that allows preprinted information to determine a visual layout that is recognizable from sign to sign, and which conveys important information usable in seller/buyer relationship.

It is a further object of this invention to provide signage that may also be written on so as to personalize the information with the object or situation to which it is displaying information about.

It is a further object of this intention to provide signage that may be placed behind glass, so that it is able to be viewed through the glass, as well as able to be placed on external surfaces that allows viewing of the signage while inside structure or vehicle.

### DESCRIPTION OF THE DRAWINGS

FIG. 1 is a side view of an motor vehicle, in which the signage is attached so that it is visible on all side glass surfaces, and also one additional signage that has been placed on the exterior side of the vehicle door.

FIG. 2 is a side view of a compact size motor vehicle, in which the signage is attached so that it is visible on all the side glass window surfaces, and also one additional signage that has been placed on the exterior side of the vehicle door.

FIG. 3 is a view of the front side of a vehicle, in which the signage is placed so that it is viewable through the windshield of the vehicle.

FIG. 4 is a view of the rear side of a vehicle, in which the signage is placed so that it is viewable through the rear window of the vehicle.

FIG. 5 is a side view of a motor vehicle door, showing two different types of signs that have been attached to the window for viewing purposes.

FIG. 6 is a view from the front of a vehicle, showing the windshield and multiple signs placed on said windshield.

FIG. 7 is a view from the front of a vehicle, showing the windshield and a single sign placed on said windshield.

FIG. 8 is a view of the front side of a building, where said building has windows that allow signage of various types to be displayed by viewing through said windows.

FIG. 9 is an example of a “for sale” sign that is useful with vehicles or buildings.

FIG. 10 is an example of a blank sign.

FIG. 11 is an example of a small sign that is usable inside vehicles for viewing by the owner or operator.

FIG. 12 is an example of a roll of signs that allows separation of the individual signs through the use of dividing perforations at predetermined intervals.

FIG. 13 is a perspective view of a dresser, in which the dresser has a mirror with signs attached to its, and a glass tray with a sign affixed to said tray.

FIG. 14 is a cross sectional view of a smooth surface such as glass, with signage adhered to one of the sides of the glass.

FIG. 15 is an example of a temporary sign that is usable with motor vehicle sales.

FIG. 16 is an example of a temporary sign that is usable with the sale of real property, such as a house.

### DETAILED DESCRIPTION OF THE INVENTION

This invention pertains to a message display media sign for placement on the interior of a motor vehicle window, structure, or various objects, to convey a custom-written message or graphic that is visible to the viewer, with multiple signs used. The sign removably adheres to smooth surfaces such as glass or plastic, including other highly polished or smooth surfaces by means of the static cling vinyl, which comprises the material used to create the signs.

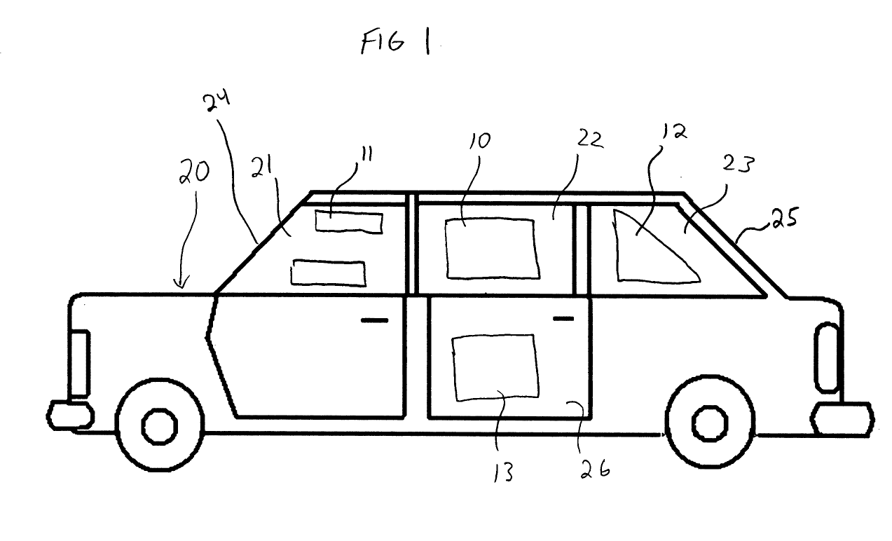

Referring now to FIG. 1, a motor vehicle 20 is shown. The example of a motor vehicle 20 is provided as a typical automobile. It should be understood that the term “motor vehicle” is intended to include any type of conveyance, such as trucks, cars, motorcycles, buses, vans scooters, watercraft, as well as aircraft, or anything which is considered as a means of transportation. FIG. 1 depicts a motor vehicle, as seen from the driver's side, in which the front driver's side window 21 is shown, as well as the back seat window 22, and rearmost window 23. Also depicted and shown is the motor vehicle door 26. All windows 21, 22 and 23 and door 26 are typically visible by any external viewer. These surfaces provide a large amount of surface area that is capable of supporting advertisements and information about the vehicle. The main sign 10 shown is exampled by a typical 8″ by 10″ sign 10, as shown placed on the back seat window 22. This sign 10 could typically contain simple information or comprehensive information depending on the other sellers desires and needs to effectively market the motor vehicle 20. Signs of a similar nature and dimensions are also exampled on the outer side of the backseat door 26, as is shown by sign 13. Since sign 13 is lower to the ground, this sign 13 may include larger printing and/or graphics. The main information about the motor vehicle 20 is more readily obtained at eye level with signs 10, 11 and 12.

As is also shown in FIG. 1, the signs 10, 11, 12, and 13 may have different shapes and dimensions. This may comprise three sides, four sides, or polygon shapes so as to follow various shapes patterns and designs according to the desires of the motor vehicle owner.

Multiple signs 10-13 allow repetitive information to be displayed on each sign, so as to highlight important features to most potential buyers. For example, the mileage and year of the vehicle might be an important consideration for all of the signs. Information regarding warranties, terms of lease, etc. may be non repetitive and placed on only one sign, or fewer than all the signs 10-13.

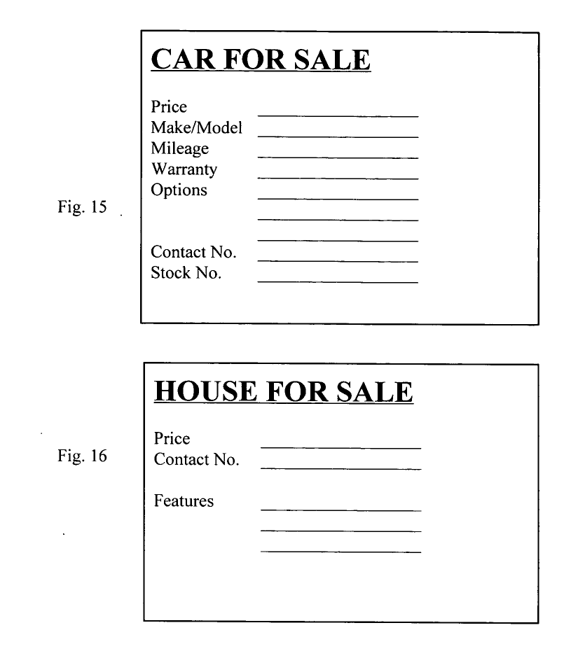

Referring now to FIG. 15, an example of the contents of sign 10 is shown. In this example, category listings such as Price, Make/Model, etc. are preprinted on the sign 10. Space is provided for the information unique to the vehicle to which it refers. The entire sign 10 may be preprinted, or have a portion preprinted with blank areas to provide data in the catagories.

As FIG. 15 shows, information is able to be conveyed in a simple easy to read format. This same format can be used on the main sign 10, as well as on all other signs 11, 12 and 13, as well as other signs that repetitively appear on the vehicle 20. This repetitive placement of information allows the potential customer to always have access to the information from multiple views of the vehicle 20. This is important, since the potential buyer is attempting to process a great deal of information and considerations, and the repetitive information provided, allows the potential buyer to consistently be reminded about the features they find important. FIG. 1 is illustrative of the driver's side only, but it should be understood that the passenger side of the vehicle 20 may have a plurality of signs as well. Further, the number of signs 10-13 should not be inferred as a limitation on the number and/or placement of said signs 10-13. Additional signs may be utilized and placed anywhere chosen.

One of the additional benefits of using multiple signs, is that the signs may be placed so as to block the necessary view for operation of the vehicle, but are easily removed, due to the non adhesive static cling attachment means. Further, since the signs 10-13, as well as other signs mentioned and referred to below, are typically mounted on the interior side of the glass, they are somewhat protected from ultraviolet radiation which causes fading. Since the signs are removable at any time, they can be simply replaced as desired. The replacement ability is crucial in advertising, since a faded sign indicates a product that hasn't sold, and lowers the seller's ability to command a higher price. In addition, this method allows the use of multiple signs, without the typical adhesion problems inherent with tape or other sticky substances that leave a residue. The use of multiple signs on a single vehicle is not a viable option if each sign presents a removal problem, such as tape residue, or other markings that indicate the presence of a previous sign.

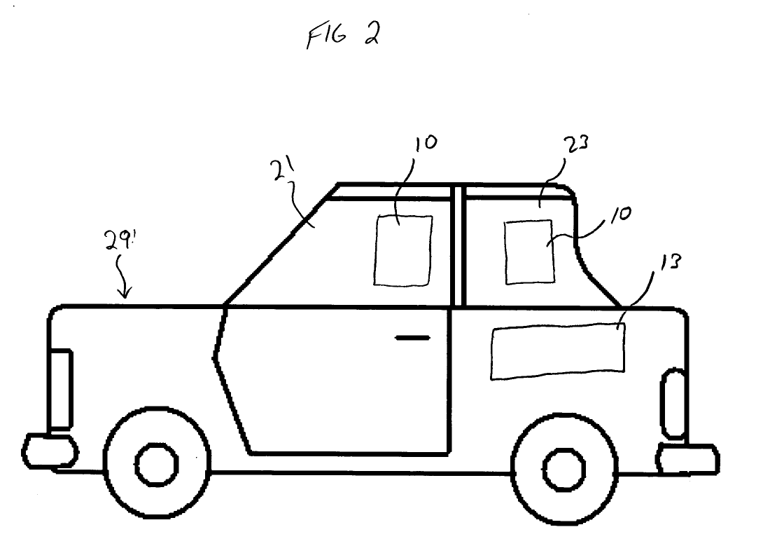

Referring now also to FIG. 2, a small economy type car or sports car 29 is shown that is able to display sign 10 on its front driver's side window 21, as well as its rear side window 23. This is similar to the motor vehicle 20 shown in FIG. 1. The economy motor vehicle 29 may also display sign 13 on its outer body panels.

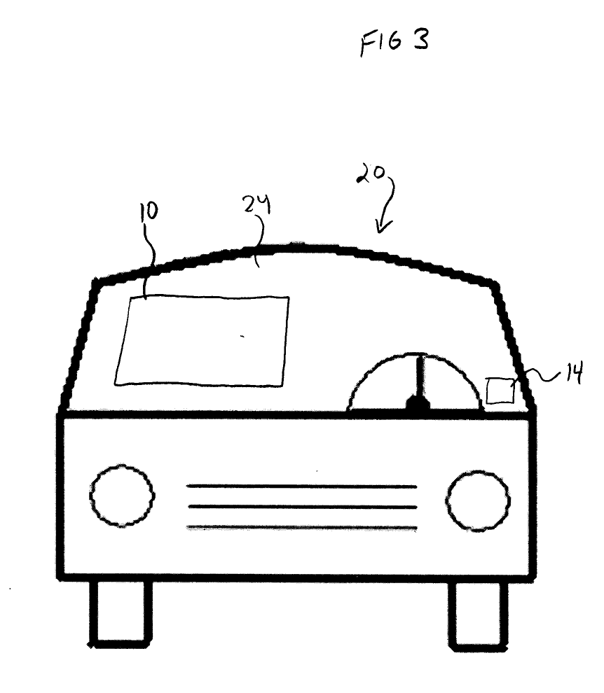

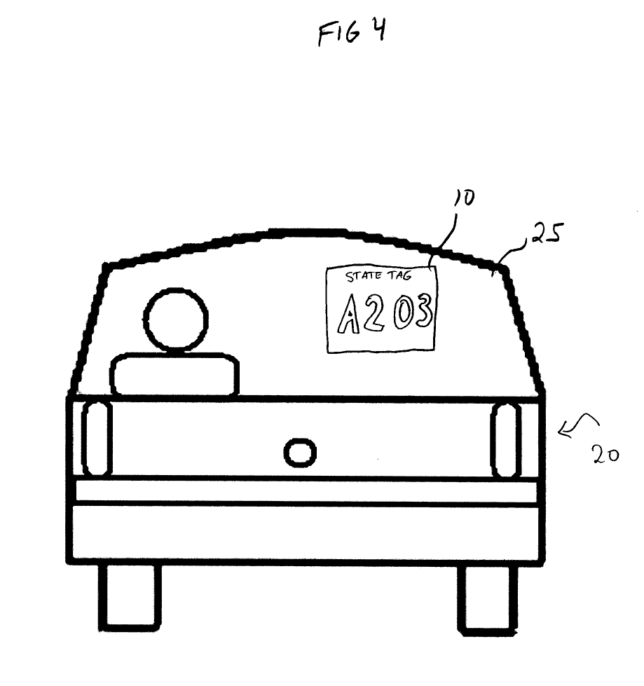

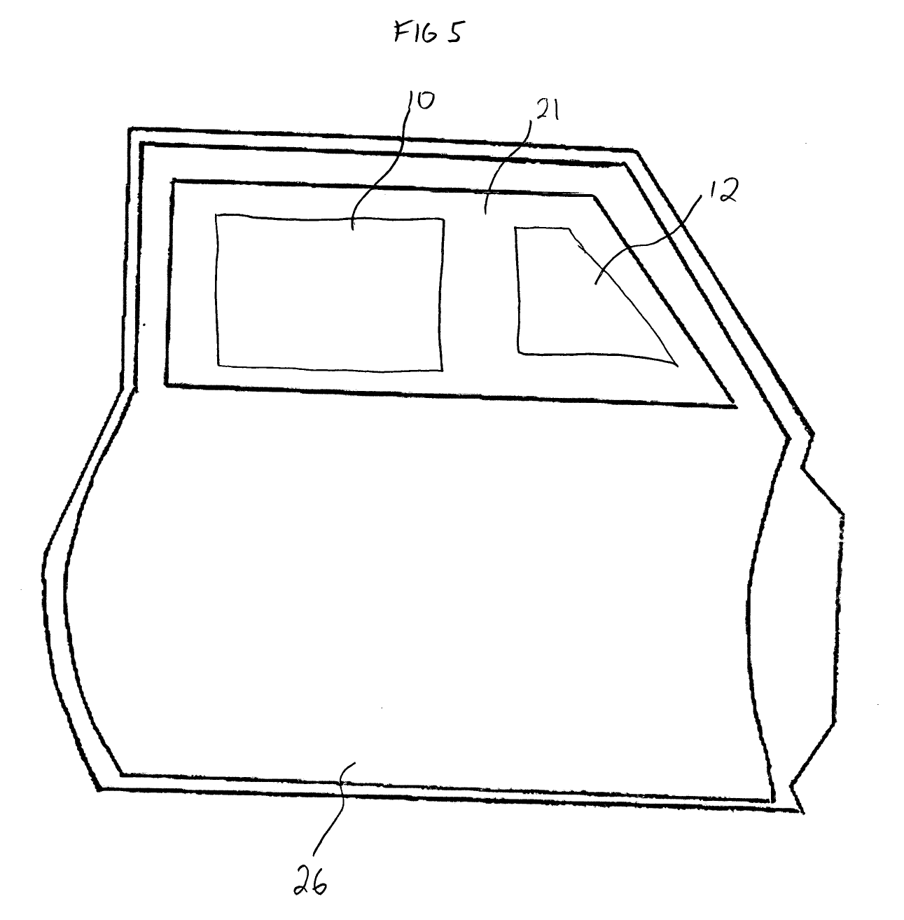

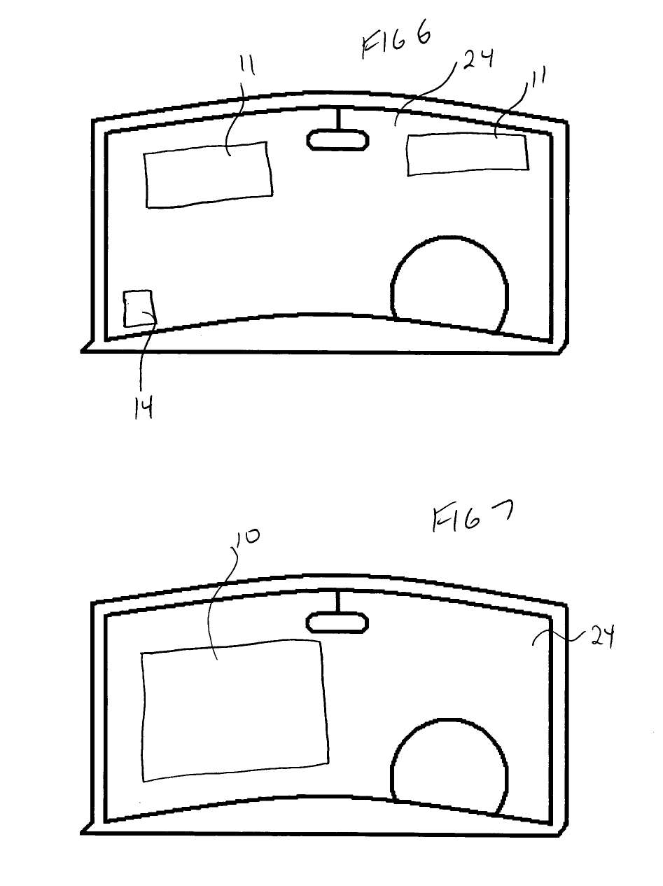

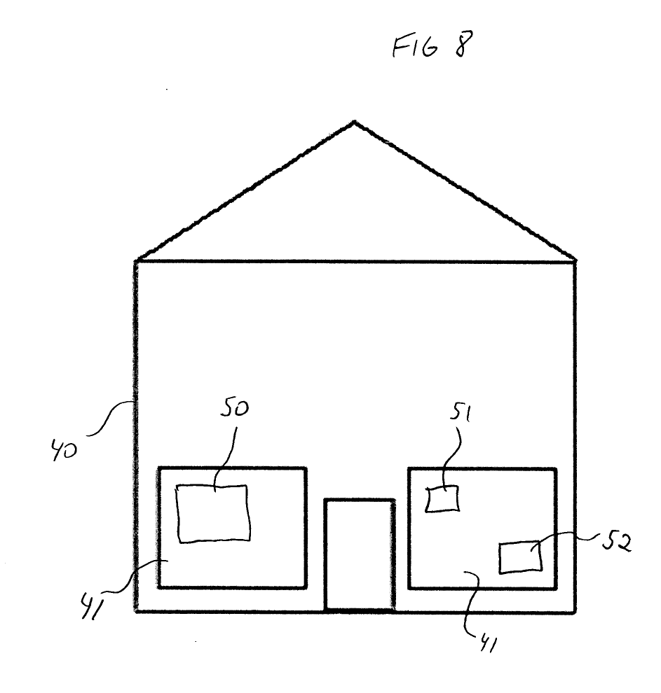

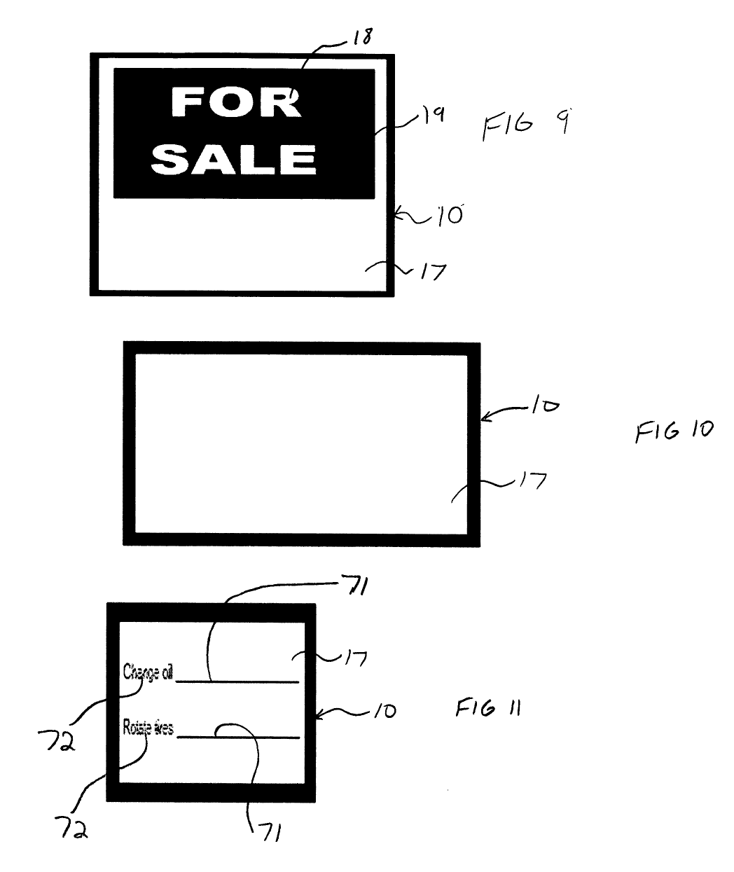

Referring now also to FIG. 3 and FIG. 4, an motor vehicle 20 is shown in both Figures, and where the sign 10 has been placed on the windshield 24. Said sign 10 is clearly visible outside of the motor vehicle 20, but it may also convey information when viewed from inside the motor vehicle 20. In this respect, the sign 10 may provide solid color sign graphics that are viewed from one direction only at a time. Other signs 10 may be transparent in some respects, in which the graphics are the only solid colors, and may viewable concurrently from both external and internal directions. Referring also to FIG. 6 and FIG. 7, sign may comprise various shapes. As is shown in FIG. 7, sign 10 comprises a rather large visually obstructive sign, that would need to be removed before operating the motor vehicle effectively and safely. FIG. 6 examples a windshield 24 with multiple signs 11 that approximately the same visual area of the single sign 10 in FIG. 7. As it is clearly seen in FIG. 6, the signs 11 do not obstruct that view of the driver in an appreciable manner. Signs 11 may comprise identical information, partially repetitive information, or have more information that is unique to each individual sign 11. In addition, as is shown in FIG. 6, a small sign 14 is also present. Multiple small signs may be used, and which may contain identical, repetitive or unique information as compared with signs 11.

Another advantage to multiple signs, is that the layout of the multiple signs may be identical with regard to graphic layout. This makes the information easier to absorb, and a more effective tool to convey information, since the viewer's familiarity with the informational layout of the signs will promote faster observation and information gathering techniques.

Referring now also to FIG. 8, a house 40 is shown, which defines large picture windows 41. Said windows 41 provide optimal areas for advertisements, either for business purposes or offers for sale. With regard to the size and multiple placements of the remaining signs 51 and 52, information may be unique, partially repetitive, or completely repetitive for each individual sign 50, 51 and 52. Since these signs 50-52 are adhered to smooth surfaces such as glass, they are readily viewed through the glass, and are easily removed when no longer needed.

Referring now also to FIG. 16, an example of the content of sign 50, 51 and 52 is shown. In this example, category listings such as Price, Contact No. And Features are preprinted on the signs 50, 51 and 52. Space is provided for the information unique to the structure to which it refers. The entire sign 10 may be preprinted, or have a portion preprinted with blank areas to provide data in the catagories.

As FIG. 16 shows, information is able to be conveyed in a simple easy to read format. This same format can be used on the main sign 50, as well as on all other signs 51 and 52, as well as other signs that repetitively appear on the structure 40. This repetitive placement of information allows the potential customer to always have access to the information from multiple views of the structure 40. This is important, since the potential buyer is attempting to process a great deal of information and considerations, and the repetitive information provided, allows the potential buyer to consistently be reminded about the features they find important. FIG. 8 is illustrative of the front side of the structure 40 only, but it should be understood that the other exterior sides of the structure 40 may have a plurality of signs as well. Further, the number of signs should not be inferred as a limitation on the number and/or placement of said signs 50-52. Additional signs may be utilized and placed anywhere chosen.

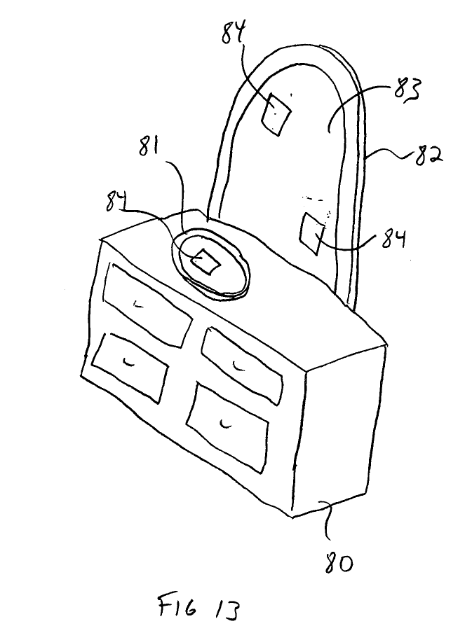

Additional signs may be used on items within structures 40. Referring now also to FIG. 13, a piece of furniture is shown, being a dresser 80, having a high back mirror 82, with a polished mirror surface 83. The signs 84 are placed on the mirror surface 83, and may display unique information, a combination of unique and repetitive information, or completely repetitive information, as compared with other signs. In addition, even small items, such as a glass tray 81, shown on the dresser 80, may have an additional sign 84. The intent of the sign 84 placement is to inundate the observer with repetitive type information, so that they are influenced to act on the information provided. The contents of the signs 84 may be also used in a business or museum setting, having language that would qualify as a reminder of “please do not touch” or other messages of similar nature.

One of the additional benefits of using multiple signs, is that the signs may be placed so as to block the necessary view for operation of the vehicle, but are easily removed, due to the non adhesive static cling attachment means. Further, since the signs 10-13, as well as other signs mentioned and referred to below, are typically mounted on the interior side of the glass, they are somewhat protected from ultraviolet radiation which causes fading. Since the signs are removable at any time, they can be simply replaced as desired. The replacement ability is crucial in advertising, since a faded sign indicates a product that hasn't sold, and lowers the seller's ability to command a higher price.

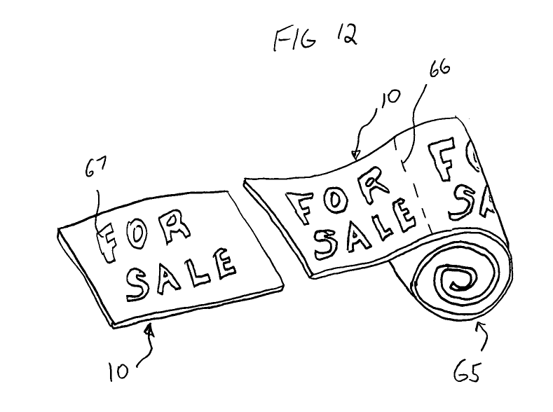

Examples of several of the types of signs available are shown in FIGS. 9, 10 and 11. FIG. 9 depicts a typical “For Sale” sign 10, which is provided with specific lettering 18, where said lettering is defined by a colored background 19. Also, a visual area 17 is provided in which to add specific and unique information. FIG. 10 provides a completely blank sign, where all information is considered unique and may be hand written. FIG. 11 is an example of the small signs that are useful for retaining and displaying specific information. In FIG. 11, sign 10 is provided with a specific category or categories of information 72, with an area 71 to place the changing or updated information. This would allow information to be updated as needed, and either replace the sign 10 with a new one, or erase and write in the new information.

Referring to FIG. 12, a roll 65 of signs 10 is shown, where each individual sign 10 is attached end to end with others, so as to form a continuous strip of signs 10. Said individual signs 10 are separated using perforations 66 that define partial cuts through the thickness of the sign 10. Separation is accomplished by simply tearing off a sign 10. Various lettering and information 67 is present thereon, and is repeated on all signs in the roll 65. This allows for easy storage, and convenient dispensing.

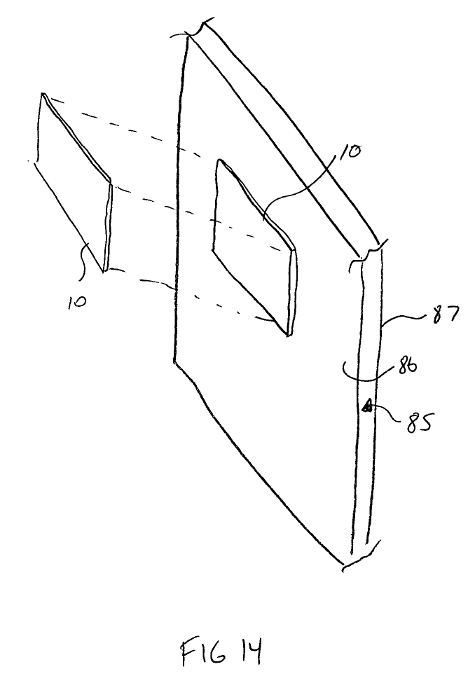

FIG. 14 depicts the placement of a sign 10 on a section of glass 85. Said glass has a first side 86 and a second side 87. In FIG. 14, the sign 10 is placed against the first side 86 of glass 85, with the static cling forces causing the entire sign 10 to be held against glass first side 86. Where sign 10 is intended for viewing from the second side 87, the lettering and graphics will be so oriented on the sign 10 that when viewed through the glass 85 from the second side 87, the sign 85 will be able to convey desired information. Where the sign 10 is intended to be viewed from the first side 86 of the glass, the graphics again will be so oriented so as convey information from that view. Views from the first side 86 and second side 87 are to be considered as opposite views.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

I claim:

1. A method of displaying information on a motor vehicle, comprising:
a. placing information on multiple signs, where the signs comprise material that is conducive to adhering to smooth receptive surfaces using static cling vinyl as the sign media material;
b. placing two or more signs on receptive surfaces of the vehicle so that they are able to be viewed by observers of the vehicle;
c. removing any desired signs from the motor vehicle;
d. placing the signs previously removed back on a motor vehicle.

2. A method of displaying information on a motor vehicle, according to claim 1, in which the information on the multiple signs comprises repetitive information common to all signs, so that every sign viewed will contain the repetitive information that is able to be viewed by an observer when looking at any sign on the motor vehicle.

3. A method of displaying information on a motor vehicle, according to claim 1, in which the information on the multiple signs comprises unique information from sign to sign, so that every sign viewed will provide unique and additional information, as compared with any other sign on the motor vehicle, so that the viewing of a combination of signs will provide more information when viewed as a whole, as compared with the viewing of a single sign.

4. A method of displaying information on a motor vehicle, according to claim 1, in which the information on the multiple signs comprises a combination of repetitive information common to all signs, and unique information that is not common to all signs, so that the total combination of signs viewed will provide additional information when viewed as a whole, as compared with the viewing of a single sign.

5. A method of displaying information on a motor vehicle, according to claim 1, in which there are signs placed on multiple sides of the motor vehicle, so that a viewer is able to view signs and their information when viewing the motor vehicle from various angles.

6. A method of displaying information on a motor vehicle, according to claim 1, in which signs vary as to shape and size.

7. A method of displaying information on a motor vehicle, according to claim 1, in which the signs are placed on the interior side of a window, so that it is viewed through the window glass, and protected from external stress.

8. A method of displaying information on a motor vehicle, according to claim 1, in which the signs are placed on the external side of the glass, in addition to signs that are placed on the internal side of the glass.

9. A method of displaying information on a structure, comprising:
a. placing information on multiple signs, where the signs comprise material that is conducive to adhering to smooth receptive surfaces using static cling vinyl as the sign media material;
b. placing two or more signs on receptive surfaces of the structure so that they are able to be viewed by observers of the structure;
c. removing any desired signs from the structure;
d. placing the signs previously removed back on the structure or a new structure.

10. A method of displaying information on a structure, according to claim 9, in which the information on the multiple signs comprises repetitive information common to all signs, so that every sign viewed will contain the repetitive information that is able to be viewed by an observer when looking at any sign on the motor vehicle.

11. A method of displaying information on a structure, according to claim 9, in which the information on the multiple signs comprises unique information from sign to sign, so that every sign viewed will provide unique and additional information, as compared with any other sign on the motor vehicle, so that the viewing of a combination of signs will provide more information when viewed as a whole, as compared with the viewing of a single sign.

12. A method of displaying information on a structure, according to claim 9, in which the information on the multiple signs comprises a combination of repetitive information common to all signs, and unique information that is not common to all signs, so that the total combination of signs viewed will provide additional information when viewed as a whole, as compared with the viewing of a single sign.

13. A method of displaying information on a structure, according to claim 9, in which there are signs placed on multiple windows of the structure, so that a viewer is able to view signs and their information when viewing the structure from various locations.

14. A method of displaying information on a structure, according to claim 9, in which signs vary as to shape and size.

15. A method of displaying information on a structure, according to claim 9, in which the signs are placed on the interior side of a window, so that it is viewed through the window glass, and protected from external stress.

16. A method of displaying information on a structure, according to claim 9, in which the signs are placed on the external side of a window, in addition to signs that are placed on the internal side of the glass.

17. A method of displaying information on a structure, according to claim 9, in which the signs are placed on items contained within a structure, in addition to any signs placed on the structure itself.
